(19) United States
(12) Patent Application Publication
(10) Pub. No.: US 2026/0066723 A1
(43) Pub. Date: Mar. 5, 2026

(54) ROTOR CORE, ROTATING ELECTRIC MACHINE, AND DRIVE DEVICE

(71) Applicant: NIDEC CORPORATION, Kyoto (JP)

(72) Inventor: Kuniaki TANAKA, Kyoto (JP)

(21) Appl. No.: 19/104,669

(22) PCT Filed: May 24, 2023
(86) PCT No.: PCT/JP2023/019388

§ 371 Date: Feb. 18, 2025

(30) Foreign Application Priority Data
Sep. 9, 2022 (JP) 2022-143890

(51) Int. Cl. H02K 1/276

(52) U.S. Cl. CPC H02K 1/2766

(57) ABSTRACT

One aspect of a rotor core of the present invention is a rotor core of a rotor rotatable around a central axis, the rotor core including a pair of first magnet holes adjacent to each other in a circumferential direction, and a first hole portion located between a pair of the first magnet holes in the circumferential direction. A pair of the first magnet holes extend in directions away from each other in the circumferential direction from the inner side in a radial direction toward the outer side in the radial direction when viewed in an axial direction. The first hole portion is provided at a position overlapping a first virtual line passing through the center in the circumferential direction between a pair of the first magnet holes and extending in the radial direction when viewed in the axial direction, and has an asymmetric shape across the first virtual line.

### CROSS-REFERENCE TO RELATED APPLICATIONS

This is the U.S. national stage of application No. PCT/JP2023/019388, filed on May 24, 2023, and priority under 35 U.S.C. § 119(a) and 35 U.S.C. § 365(b) is claimed from Japanese Patent Application No. 2022-143890, filed on Sep. 9, 2022.

### FIELD OF THE INVENTION

The present invention relates to a rotor core, a rotating electric machine, and a drive device.

The present application claims priority based on Japanese Patent Application No. 2022-143890 filed in Japan on Sep. 9, 2022, the contents of which are incorporated herein by reference.

### BACKGROUND

A rotor core having a cavity between a pair of permanent magnets arranged in a V shape is known. For example, there is known a cavity having a triangular axial cross section as a cavity of such a rotor core.

For example, it is conceivable to cause a refrigerant such as oil to flow into the cavity of the rotor core as described above for the purpose of cooling the permanent magnet. In this case, the larger the cavity, the easier it is to cool the permanent magnet. However, there has been a problem that, when the cavity is large, rigidity of the rotor core is lowered.

### SUMMARY

One aspect of a rotor core of the present invention is a rotor core of a rotor rotatable around a central axis, the rotor core including a pair of first magnet holes adjacent to each other in a circumferential direction, and a first hole portion located between a pair of the first magnet holes in the circumferential direction. A pair of the first magnet holes extend in directions away from each other in the circumferential direction from the inner side in a radial direction toward the outer side in the radial direction when viewed in an axial direction. The first hole portion is provided at a position overlapping a first virtual line passing through the center in the circumferential direction between a pair of the first magnet holes and extending in the radial direction when viewed in the axial direction, and has an asymmetric shape across the first virtual line.

One aspect of a rotating electric machine of the present invention includes a rotor including the rotor core, and a stator facing the rotor with a gap interposed between them in the radial direction.

One aspect of a drive device of the present invention includes the rotating electric machine described above, and a gear mechanism connected to the rotating electric machine.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram schematically illustrating a drive device according to a first embodiment;

FIG. 2 is a cross-sectional view illustrating a rotor in the first embodiment;

FIG. 3 is a cross-sectional view illustrating a part of the rotor in the first embodiment;

FIG. 4 is a cross-sectional view illustrating a part of a rotor core in the first embodiment;

FIG. 5 is a cross-sectional view illustrating a part of the rotor core of the first embodiment, and is a partially enlarged view of FIG. 4;

FIG. 6 is a cross-sectional view illustrating a part of the rotor core in a second embodiment;

FIG. 7 is a cross-sectional view illustrating a part of the rotor core in a third embodiment;

FIG. 8 is a cross-sectional view illustrating a part of the rotor core in a fourth embodiment;

FIG. 9 is a cross-sectional view illustrating a part of the rotor core in a fifth embodiment;

FIG. 10 is a cross-sectional view illustrating a part of the rotor in a sixth embodiment; and

FIG. 11 is a cross-sectional view illustrating a part of the rotor in a seventh embodiment.

### DETAILED DESCRIPTION

Description below will be made with a vertical direction being defined based on a positional relationship in a case where a drive device of an embodiment is mounted in a vehicle located on a horizontal road surface. That is, a relative positional relationship regarding the vertical direction described in the embodiment below only needs to be satisfied at least in a case where the drive device is mounted on a vehicle located on a horizontal road surface.

The drawings illustrate an XYZ coordinate system appropriately as a three-dimensional orthogonal coordinate system. In the XYZ coordinate system, a Z axis direction is the vertical direction. A +Z side is a vertically upper side, and a −Z side is a vertically lower side. In description below, a vertically upper side will be simply referred to as “upper side” and a vertically lower side will be simply referred to as “lower side”. An X axis direction is a direction orthogonal to the Z axis direction and is a front-rear direction of a vehicle mounted with the drive device. In embodiment below, a +X side is a front side of a vehicle, and a −X side is a rear side of the vehicle. A Y axis direction is a direction orthogonal to both the X axis direction and the Z axis direction, and is a left-right direction of a vehicle, that is, a vehicle width direction. In embodiment below, a +Y side is a left side of a vehicle, and a −Y side is a right side of a vehicle. The front-rear direction and the left-right direction are a horizontal direction orthogonal to the vertical direction.

Note that a positional relationship in the front-rear direction is not limited to a positional relationship in an embodiment below, and the +X side may be the rear side of a vehicle and the −X side may be the front side of a vehicle. In this case, the +Y side is the right side of a vehicle, and the −Y side is the left side of a vehicle. Further, in the present description, a “parallel direction” includes a substantially parallel direction, and an “orthogonal direction” includes a substantially orthogonal direction.

A central axis J illustrated in the drawings as appropriate is a virtual axis extending in a direction intersecting the vertical direction. More specifically, the central axis J extends in the Y axis direction orthogonal to the vertical direction, that is, the left-right direction of a vehicle. In description below, unless otherwise stated, a direction parallel to the central axis J is simply referred to as “axial direction”, a radial direction about the central axis J is simply referred to as “radial direction”, and a circumferential direction about the central axis J, that is, a direction about the central axis J is simply referred to as “circumferential direction”. In an embodiment below, the left side (+Y side) is referred to as “one side in the axial direction”, and the right side (−Y side) is referred to as “the other side in the axial direction”.

### First Embodiment

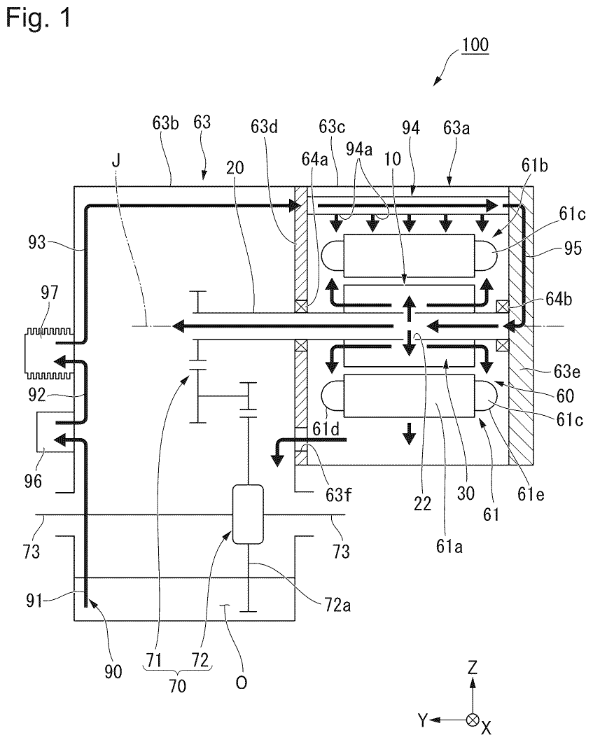

A drive device 100 of the present embodiment illustrated in FIG. 1 is a drive device that is mounted on a vehicle and rotates an axle 73. A vehicle in which the drive device 100 is mounted is a vehicle including a motor as a power source, such as a hybrid vehicle (HEV), a plug-in hybrid vehicle (PHV), or an electric vehicle (EV). As illustrated in FIG. 1, the drive device 100 includes a rotating electric machine 60, a gear mechanism 70 connected to the rotating electric machine 60, and a housing 63 accommodating the rotating electric machine 60 and the gear mechanism 70 in the inside. In the present embodiment, the rotating electric machine 60 is a motor.

The housing 63 accommodates the rotating electric machine 60 and the gear mechanism 70 in the inside. The housing 63 includes a motor housing 63a that accommodates the rotating electric machine 60 in the inside and a gear housing 63b that accommodates the gear mechanism 70 in the inside. The motor housing 63a is connected to the other side in the axial direction (−Y side) of the gear housing 63b. The motor housing 63a has a peripheral wall portion 63c, a partition wall portion 63d, and a lid portion 63e. The peripheral wall portion 63c and the partition wall portion 63d are a part of an identical single member, for example. The lid portion 63e is, for example, a separate body from the peripheral wall portion 63c and the partition wall portion 63d.

The peripheral wall portion 63c has a tubular shape that surrounds the central axis J and opens to the other side in the axial direction (−Y side). The partition wall portion 63d is connected to an end on the one side in the axial direction (+Y side) of the peripheral wall portion 63c. The partition wall portion 63d separates the inside of the motor housing 63a and the inside of the gear housing 63b in the axial direction. The partition wall portion 63d has a partition wall opening 63f that connects the inside of the motor housing 63a and the inside of the gear housing 63b. A bearing 64a is held by the partition wall portion 63d. The lid portion 63e is fixed to an end portion on the other side in the axial direction of the peripheral wall portion 63c. The lid portion 63e closes an opening on the other side in the axial direction of the peripheral wall portion 63c. A bearing 64b is held by the lid portion 63e.

The gear housing 63b accommodates oil O in the inside. The oil O is stored in a lower region in the gear housing 63b. The oil O is circulated through a flow path 90, which will be described below. The oil O is used as a refrigerant for cooling the rotating electric machine 60. The oil O is used as lubricating oil for the gear mechanism 70. As the oil O, it is preferable to use oil equivalent to an automatic transmission fluid (ATF) having relatively low viscosity in order to achieve a function of a refrigerant and lubricating oil, for example.

The gear mechanism 70 is connected to the rotating electric machine 60 and transmits rotation of a rotor 10 described later to the axle 73 of a vehicle. The gear mechanism 70 of the present embodiment includes a reduction gear 71 connected to the rotating electric machine 60 and a differential gear 72 connected to the reduction gear 71. The differential gear 72 includes a ring gear 72a. To the ring gear 72a, torque output from the rotating electric machine 60 is transmitted via the reduction gear 71. An end portion of the lower side of the ring gear 72a is immersed in the oil O stored in the gear housing 63b. Rotation of the ring gear 72a scoops up the oil O. The oil O that is scooped up is supplied as lubricating oil to, for example, the reduction gear 71 and the differential gear 72.

The rotating electric machine 60 includes the rotor 10 rotatable about the central axis J, and a stator 61 facing the rotor 10 with a gap in the radial direction interposed between them. In the present embodiment, the stator 61 is located on the outer side in the radial direction of the rotor 10. The stator 61 includes a stator core 61a and a coil assembly 61b attached to the stator core 61a. The coil assembly 61b includes a plurality of coils 61c attached to the stator core 61a. Although not illustrated, the coil assembly 61b may include a binding member or the like to bind the coils 61c together, and may include an interconnecting wire for connecting the coils 61c to one another. The coil assembly 61b has coil ends 61d and 61e protruding in the axial direction more than the stator core 61a.

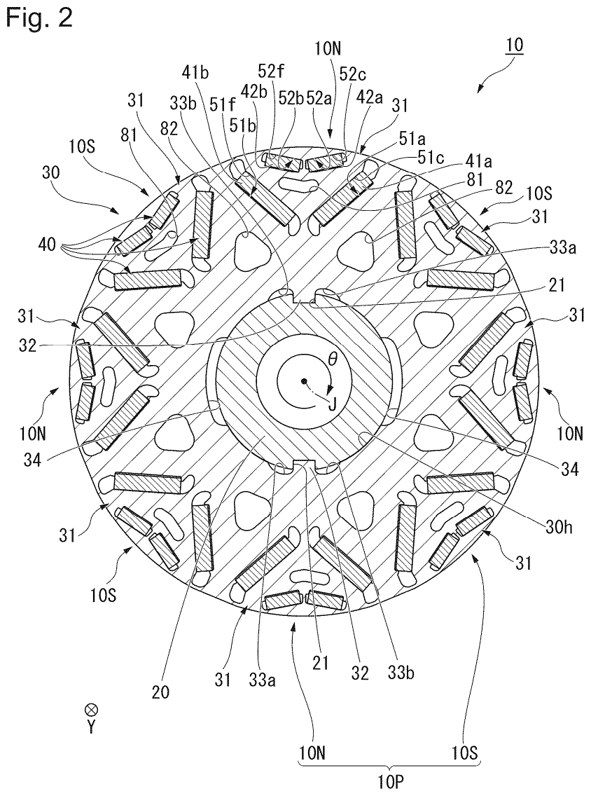

As illustrated in FIG. 2, the rotor 10 includes a shaft 20, a rotor core 30, and a plurality of magnets 40. As illustrated in FIG. 1, the shaft 20 extends in the axial direction around the central axis J. An end portion on the one side in the axial direction (+Y side) of the shaft 20 protrudes into the gear housing 63b. As illustrated in FIG. 2, in the present embodiment, the shaft 20 is a cylindrical hollow shaft around the central axis J. The shaft 20 has a groove portion 21 recessed to the inner side in the radial direction from an outer peripheral surface of the shaft 20. Although not illustrated, the groove portion 21 extends in the axial direction. A pair of the groove portions 21 are provided with the central axis J interposed between them in the radial direction. As illustrated in FIG. 1, the shaft 20 is provided with a hole portion 22 that connects the inside of the shaft 20 and the outside of the shaft 20. A plurality of the hole portions 22 are provided at intervals in the circumferential direction.

As illustrated in FIG. 2, the rotor core 30 is fixed to an outer peripheral surface of the shaft 20. The rotor core 30 has a substantially cylindrical shape around the central axis J. The rotor core 30 has a through hole 30h that penetrates the rotor core 30 in the axial direction. The central axis J passes through the through hole 30h. In the present embodiment, the through hole 30h is a substantially circular hole around the central axis J. The shaft 20 passes through the through hole 30h in the axial direction. An inner peripheral surface of the through hole 30h is fixed to an outer peripheral surface of the shaft 20. For example, the shaft 20 is press-fitted into the through hole 30h.

An inner edge of the through hole 30h is provided with a projection portion 32 protruding to the inner side in the radial direction. Although not illustrated, the projection portion 32 extends in the axial direction. A pair of the projection portions 32 are provided with the central axis J interposed between them in the radial direction. A pair of the projection portions 32 are fitted into a pair of the groove portions 21. By the above, the shaft 20 and the rotor core 30 are caught with each other in the circumferential direction, and relative rotation of the shaft 20 and the rotor core 30 in the circumferential direction is suppressed.

An inner edge of the through hole 30h is provided with a pair of first recessed portions 33a and 33b and a second recessed portion 34 recessed to the outer side in the radial direction. Two pairs of the first recessed portions 33a and 33b are provided with the central axis J interposed between them in the radial direction. Each pair of the first recessed portions 33a and 33b are provided adjacent to both sides in the circumferential direction of each of the projection portions 32 with each of the projection portions 32 interposed between them in the circumferential direction. A pair of the second recessed portions 34 are provided with the central axis J interposed between them in the radial direction. A pair of the second recessed portions 34 are arranged by sandwiching the central axis J in the radial direction orthogonal to the radial direction in which a pair of the projection portions 32 sandwiches the central axis J when viewed in the axial direction. A pair of the second recessed portions 34 extend in the circumferential direction. Since the first recessed portions 33a and 33b and the second recessed portion 34 are provided, a part of stress generated in the shaft 20 when the shaft 20 is press-fitted into the through hole 30h can be released in a portion facing the first recessed portions 33a and 33b and the second recessed portion 34 of the shaft 20 in the radial direction. Therefore, the shaft 20 can be easily press-fitted into the through hole 30h.

Note that a groove portion may be provided on an inner edge of the through hole 30h instead of the projection portion 32, and a projection portion fitted to the groove portion provided on an inner edge of the through hole 30h may be provided on an outer peripheral surface of the shaft 20 instead of the groove portion 21. Even in this case, it is possible to suppress relative rotation of the shaft 20 and the rotor core 30 in the circumferential direction.

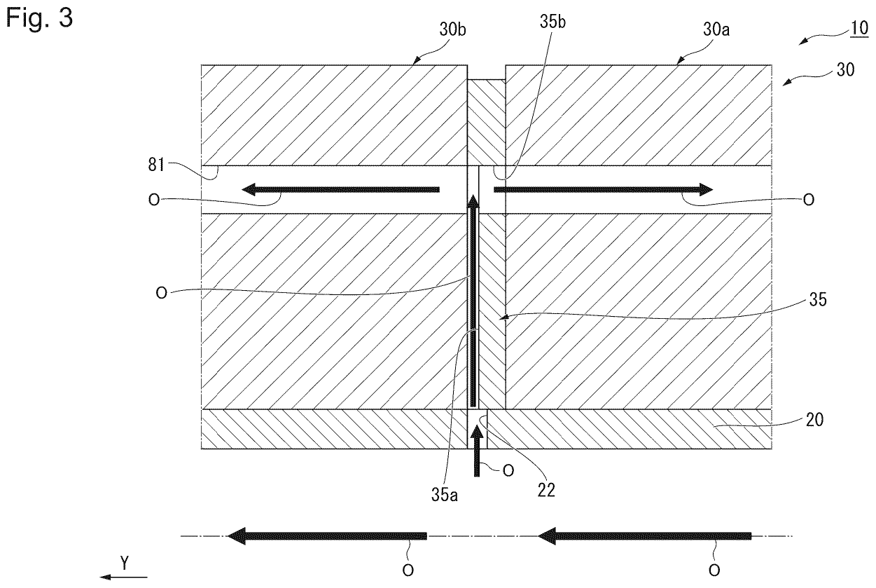

The rotor core 30 is made from a magnetic body. Although not illustrated, the rotor core 30 includes a plurality of plate members laminated in the axial direction. The plate member is, for example, an electromagnetic steel plate. As illustrated in FIG. 3, the rotor core 30 includes a plurality of core piece portions 30a and 30b. The core piece portion 30a and the core piece portion 30b are arranged in the axial direction. The core piece portion 30b is located on the one side in the axial direction (+Y side) of the core piece portion 30a. A plate 35 is provided between the core piece portion 30a and the core piece portion 30b in the axial direction.

The plate 35 is arranged between the core piece portion 30a and the core piece portion 30b adjacent to each other in the axial direction. The plate 35 has an annular shape surrounding the shaft 20. More specifically, the plate 35 has an annular shape around the central axis J. In the present embodiment, the plate 35 has a plate shape whose plate surface faces the axial direction. A surface on the other side in the axial direction (−Y side) of the plate 35 is in contact with the core piece portion 30a. A surface on the one side in the axial direction (+Y side) of the plate 35 is in contact with the core piece portion 30b.

The plate 35 has a groove portion 35a and a hole portion 35b. In the present embodiment, the groove portion 35a is provided on a surface on the one side in the axial direction (+Y side) of the plate 35. The groove portion 35a extends to the outer side in the radial direction from an inner edge in the radial direction of the plate 35. An end portion on the outer side in the radial direction of the groove portion 35a is located separately on the inner side in the radial direction more than an end portion on the outer side in the radial direction of the plate 35. An opening on the one side in the axial direction of the groove portion 35a is closed by the core piece portion 30b. The hole portion 35b penetrates a portion where an end portion on the outer side in the radial direction of the groove portion 35a is provided in the plate 35. The hole portion 35b is connected to an end portion on the outer side in the radial direction of the groove portion 35a. An end portion on the outer side in the radial direction of the groove portion 35a and the hole portion 35b are connected to a first hole portion 81 described later. Although not illustrated, a plurality of the groove portions 35a and a plurality of the hole portions 35b are provided at intervals in the circumferential direction.

As illustrated in FIG. 2, the rotor core 30 includes a plurality of magnet holding portions 31 arranged side by side in the circumferential direction. A plurality of the magnet holding portions 31 are provided in an outer portion in the radial direction of the rotor core 30. A plurality of the magnet holding portions 31 are arranged at equal intervals over the entire circumference along the circumferential direction. In the present embodiment, eight of the magnet holding portions 31 are provided.

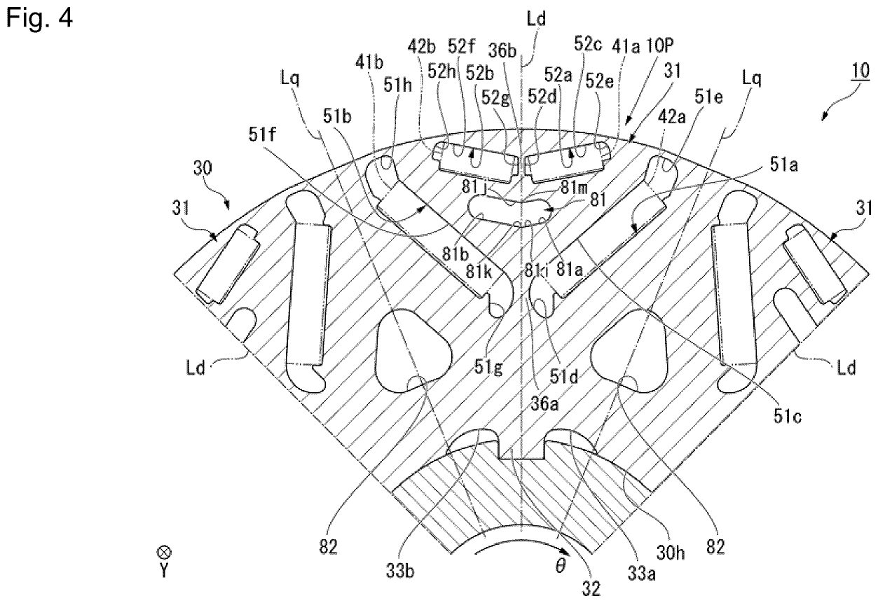

As illustrated in FIG. 4, each of a plurality of the magnet holding portions 31 includes a pair of first magnet holes 51a and 51b adjacent to each other in the circumferential direction, and a pair of second magnet holes 52a and 52b located on the outer side in the radial direction of a pair of the first magnet holes 51a and 51b and adjacent to each other in the circumferential direction. That is, the rotor core 30 has a pair of the first magnet holes 51a and 51b and a pair of the second magnet holes 52a and 52b. As described above, in the present embodiment, each of the magnet holding portions 31 is provided with a total of four magnet holes, a pair of the first magnet holes 51a and 51b and a pair of the second magnet holes 52a and 52b. In the present embodiment, a pair of the first magnet holes 51a and 51b and a pair of the second magnet holes 52a and 52b penetrate the rotor core 30 in the axial direction. Note that a pair of the first magnet holes 51a and 51b and a pair of the second magnet holes 52a and 52b may be holes having a bottom portion at an end portion in the axial direction.

As illustrated in FIG. 2, one of the magnets 40 is arranged in each of the four magnet holes in each of the magnet holding portions 31. A type of the magnet 40 is not particularly limited. The magnet 40 may be, for example, a neodymium magnet or a ferrite magnet. The magnet 40 has, for example, a rectangular parallelepiped shape elongated in the axial direction. The magnet 40 extends, for example, from one end portion in the axial direction to another end portion in the axial direction of the rotor core 30.

A plurality of the magnets 40 include a pair of first magnets 41a and 41b arranged in a pair of the first magnet holes 51a and 51b, respectively, and a pair of second magnets 42a and 42b arranged in a pair of the second magnet holes 52a and 52b, respectively. Each of the magnets 40 is fixed in each magnet hole. A method of fixing each of the magnets 40 into each magnet hole is not particularly limited. For example, each magnet may be fixed into each magnet hole by crimping a part of the rotor core 30, may be fixed in each magnet hole by resin filled in a portion other than a portion where the magnet 40 is arranged in each magnet hole, or may be fixed in each magnet hole by a foam sheet arranged in a portion other than a portion where the magnet 40 is arranged in each magnet hole.

As illustrated in FIG. 2, one of the magnet holding portions 31 and a plurality of the magnets 40 arranged in a plurality of magnet holes provided in one of the magnet holding portions 31 constitute a magnetic pole portion 10P. A plurality of the magnetic pole portions 10P are arranged at equal intervals over the entire circumference along the circumferential direction. In the present embodiment, eight of the magnetic pole portions 10P are provided. A plurality of the magnetic pole portions 10P include a plurality of magnetic pole portions 10N in which a magnetic pole on an outer peripheral surface of the rotor core 30 is an N pole and a plurality of magnetic pole portions 10S in which a magnetic pole on an outer peripheral surface of the rotor core 30 is an S pole. In the present embodiment, four of the magnetic pole portions 10N and four of the magnetic pole portions 10S are provided. Four of the magnetic pole portions 10N and four of the magnetic pole portions 10S are alternately arranged along the circumferential direction. Configurations of the magnetic pole portions 10P are similar to one another except that magnetic poles on an outer peripheral surface of the rotor core 30 are different and circumferential positions are different.

As illustrated in FIG. 4, in the magnetic pole portion 10P, the first magnet hole 51a and the first magnet hole 51b are arranged with a first virtual line Ld interposed between them in the circumferential direction. The first virtual line Ld is a virtual line that passes through the center in the circumferential direction between a pair of the first magnet holes 51a and 51b and extends in the radial direction. The first virtual line Ld is a magnetic pole center line passing through the center in the circumferential direction of the magnetic pole portion 10P. The center in the circumferential direction of the magnetic pole portion 10P is the center in the circumferential direction of the magnet holding portion 31. The first virtual line Ld is provided for each of the magnetic pole portions 10P. The first virtual line Ld passes on a d axis of the rotor 10 when viewed in the axial direction. A direction in which the first virtual line Ld extends is the d axis direction of the rotor 10. The first magnet hole 51a and the first magnet hole 51b are arranged in line symmetry with the first virtual line Ld as a symmetry axis when viewed in the axial direction.

A pair of the first magnet holes 51a and 51b extend in directions away from each other in the circumferential direction toward the outer side in the radial direction from the inner side in the radial direction when viewed in the axial direction. That is, a distance in the circumferential direction between the first magnet hole 51a and the first magnet hole 51b increases toward the outer side in the radial direction from the inner side in the radial direction. A pair of the first magnet holes 51a and 51b are arranged along a V shape expanding in the circumferential direction toward the outer side in the radial direction when viewed in the axial direction.

The first magnet hole 51a includes a magnet accommodation hole portion 51c, an inner hole portion 51d, and an outer hole portion 51e. The magnet accommodation hole portion 51c is a rectangular hole that is long in a direction in which the first magnet hole 51a extends when viewed in the axial direction. The inner hole portion 51d is connected to an end portion on the inner side in the radial direction of an end portion of the magnet accommodation hole portion 51c in a direction in which the magnet accommodation hole portion 51c extends when viewed in the axial direction. The outer hole portion 51e is connected to an end portion on the outer side in the radial direction of an end portion of the magnet accommodation hole portion 51c in a direction in which the magnet accommodation hole portion 51c extends when viewed in the axial direction.

The first magnet hole 51b includes a magnet accommodation hole portion 51f, an inner hole portion 51g, and an outer hole portion 51h. The magnet accommodation hole portion 51f is a rectangular hole that is long in a direction in which the first magnet hole 51b extends when viewed in the axial direction. The inner hole portion 51g is connected to an end portion on the inner side in the radial direction of an end portion of the magnet accommodation hole portion 51f in a direction in which the magnet accommodation hole portion 51f extends when viewed in the axial direction. The outer hole portion 51h is connected to an end portion on the outer side in the radial direction of an end portion of the magnet accommodation hole portion 51f in a direction in which the magnet accommodation hole portion 51f extends when viewed in the axial direction.

The inner hole portion 51d and the inner hole portion 51g are arranged at intervals in the circumferential direction with the first virtual line Ld interposed between them in the circumferential direction. In each of the inner hole portion 51d and the inner hole portion 51g, an edge portion on a side close to an inner hole portion of the other has a substantially arc shape that is recessed toward the inner hole portion of the other when viewed in the axial direction. A portion between the inner hole portion 51d and the inner hole portion 51g in the circumferential direction in the rotor core 30 is a first bridge portion 36a located between a pair of the first magnet holes 51a and 51b. That is, the rotor core 30 includes the first bridge portion 36a. The first bridge portion 36a is located between inner end portions in the radial direction of a pair of the first magnet holes 51a and 51b in the circumferential direction. The first bridge portion 36a extends in the radial direction. A dimension in the circumferential direction of an outer portion in the radial direction of the first bridge portion 36a increases toward the outer side in the radial direction. A dimension in the circumferential direction of an inner portion in the radial direction of the first bridge portion 36a increases toward the inner side in the radial direction.

A pair of the first magnets 41a and 41b arranged in a pair of the first magnet holes 51a and 51b are arranged along a V shape expanding in the circumferential direction toward the outer side in the radial direction when viewed in the axial direction. The first magnet 41a is arranged in the magnet accommodation hole portion 51c of the first magnet hole 51a. The first magnet 41b is arranged in the magnet accommodation hole portion 51f of the first magnet hole 51b. The inner hole portions 51d and 51g and the outer hole portions 51e and 51h are, for example, hollow portions, and each constitute a flux barrier portion. Note that the inner hole portions 51d and 51g and the outer hole portions 51e and 51h may be filled with a non-magnetic material such as resin, and each hole portion and the non-magnetic material such as resin filling each hole portion may constitute a flux barrier portion. Note that in the present description, “flux barrier portion” is a portion that can suppress flow of a magnetic flux. That is, a magnetic flux hardly passes through each flux barrier portion.

A pair of the second magnet holes 52a and 52b are located on the outer side in the radial direction of a pair of the first magnet holes 51a and 51b. The second magnet hole 52a is located on the outer side in the radial direction of the first magnet hole 51a. The second magnet hole 52b is located on the outer side in the radial direction of the first magnet hole 51b. A pair of the second magnet holes 52a and 52b are arranged between a pair of the first magnet holes 51a and 51b in the circumferential direction. More specifically, a pair of the second magnet holes 52a and 52b are arranged between the outer hole portions 51e and 51h of a pair of the first magnet holes 51a and 51b in the circumferential direction.

In the magnetic pole portion 10P, the second magnet hole 52a and the second magnet hole 52b are arranged with the first virtual line Ld interposed between them in the circumferential direction. That is, the first virtual line Ld passes between a pair of the second magnet holes 52a and 52b when viewed in the axial direction. In the present embodiment, the first virtual line Ld passes through the center in the circumferential direction between a pair of the second magnet holes 52a and 52b when viewed in the axial direction. The second magnet hole 52a and the second magnet hole 52b are arranged in line symmetry with the first virtual line Ld as a symmetry axis when viewed in the axial direction.

A pair of the second magnet holes 52a and 52b extend in directions away from each other in the circumferential direction toward the outer side in the radial direction from the inner side in the radial direction when viewed in the axial direction. That is, a distance in the circumferential direction between the second magnet hole 52a and the second magnet hole 52b increases toward the outer side in the radial direction from the inner side in the radial direction. A pair of the second magnet holes 52a and 52b are arranged along a V shape expanding in the circumferential direction toward the outer side in the radial direction when viewed in the axial direction. When viewed in the axial direction, an inclination with respect to the radial direction of a direction in which a pair of the second magnet holes 52a and 52b extend is larger than an inclination with respect to the radial direction of a direction in which a pair of the first magnet holes 51a and 51b extend. An opening angle of a V shape formed by a pair of the second magnet holes 52a and 52b is larger than an opening angle of a V shape formed by a pair of the first magnet holes 51a and 51b.

The second magnet hole 52a includes a magnet accommodation hole portion 52c, an inner hole portion 52d, and an outer hole portion 52e. The magnet accommodation hole portion 52c is a rectangular hole that is long in a direction in which the second magnet hole 52a extends when viewed in the axial direction. The inner hole portion 52d is connected to an end portion on the inner side in the radial direction of an end portion of the magnet accommodation hole portion 52c in a direction in which the magnet accommodation hole portion 52c extends when viewed in the axial direction. The outer hole portion 52e is connected to an end portion on the outer side in the radial direction of an end portion of the magnet accommodation hole portion 52c in a direction in which the magnet accommodation hole portion 52c extends when viewed in the axial direction.

The second magnet hole 52b includes a magnet accommodation hole portion 52f, an inner hole portion 52g, and an outer hole portion 52h. The magnet accommodation hole portion 52f is a rectangular hole that is long in a direction in which the second magnet hole 52b extends when viewed in the axial direction. The inner hole portion 52g is connected to an end portion on the inner side in the radial direction of an end portion of the magnet accommodation hole portion 52f in a direction in which the magnet accommodation hole portion 52f extends when viewed in the axial direction. The outer hole portion 52h is connected to an end portion on the outer side in the radial direction of an end portion of the magnet accommodation hole portion 52f in a direction in which the magnet accommodation hole portion 52f extends when viewed in the axial direction.

The inner hole portion 52d and the inner hole portion 52g are arranged at intervals in the circumferential direction with the first virtual line Ld interposed between them in the circumferential direction. An interval in the circumferential direction between the inner hole portion 52d and the inner hole portion 52g is smaller than an interval in the circumferential direction between the inner hole portion 51d and the inner hole portion 51g. In each of the inner hole portion 52d and the inner hole portion 52g, an edge portion on a side close to an inner hole portion of the other extends linearly along the first virtual line Ld when viewed in the axial direction. An inner end portion in the radial direction of the inner hole portions 52d and 52g is located further on the outer side in the radial direction than an inner end portion in the radial direction of the magnet accommodation hole portions 52c and 52f.

A second bridge portion 36b located between a pair of the second magnet holes 52a and 52b is provided between the inner hole portion 52d and the inner hole portion 52g in the circumferential direction. That is, the rotor core 30 has the second bridge portion 36b. The second bridge portion 36b is located between inner end portions in the radial direction of a pair of the second magnet holes 52a and 52b in the circumferential direction. The second bridge portion 36b extends in the radial direction.

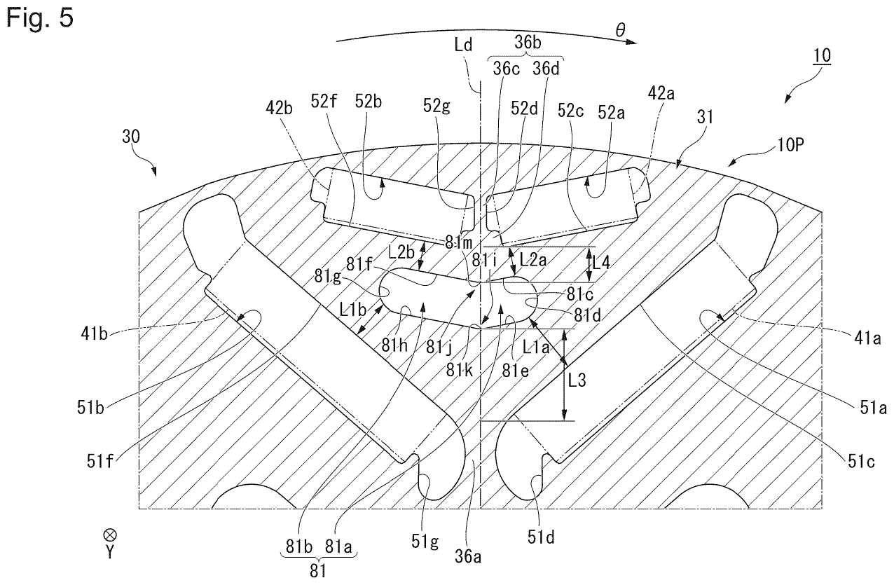

As illustrated in FIG. 5, the second bridge portion 36b has a narrow portion 36c and a wide portion 36d. The narrow portion 36c is an outer portion in the radial direction of the second bridge portion 36b. A dimension in the circumferential direction of the narrow portion 36c is smaller than a dimension in the circumferential direction of the first bridge portion 36a. The narrow portion 36c is a portion located between the inner hole portion 52d and the inner hole portion 52g in the circumferential direction in the rotor core 30. The wide portion 36d is connected to the inner side in the radial direction of the narrow portion 36c. The wide portion 36d is an inner portion in the radial direction of the second bridge portion 36b. The wide portion 36d is a portion located between an inner end portion in the radial direction of the magnet accommodation hole portion 52c and an inner end portion in the radial direction of the magnet accommodation hole portion 52f in the circumferential direction in the rotor core 30. A dimension in the circumferential direction of the wide portion 36d is larger than a dimension in the circumferential direction of the narrow portion 36c. A dimension in the circumferential direction of the wide portion 36d is larger than a minimum dimension among dimensions in the circumferential direction of the first bridge portion 36a. In the present embodiment, the minimum dimension among dimensions in the circumferential direction of the first bridge portion 36a is a dimension in the circumferential direction at a central portion in the radial direction of the first bridge portion 36a.

As illustrated in FIG. 4, a pair of the second magnets 42a and 42b arranged in a pair of the second magnet holes 52a and 52b are arranged along a V shape expanding in the circumferential direction toward on the outer side in the radial direction when viewed in the axial direction. That is, in each of the magnetic pole portions 10P of the present embodiment, two pairs of the magnets 40 arranged along a V shape when viewed in the axial direction are provided side by side in the radial direction. The second magnet 42a is arranged in the magnet accommodation hole portion 52c of the second magnet hole 52a. The second magnet 42b is arranged in the magnet accommodation hole portion 52f of the second magnet hole 52b. The inner hole portions 52d and 52g and the outer hole portions 52e and 52h are, for example, hollow portions, and each constitute a flux barrier portion. Note that the inner hole portions 52d and 52g and the outer hole portions 52e and 52h may be filled with a non-magnetic material such as resin, and each hole portion and the non-magnetic material such as resin filling each hole portion may constitute a flux barrier portion.

Note that, in the present description, “direction in which the magnet hole extends when viewed in the axial direction” is a direction in which a long side of the magnet accommodation hole portion extends when viewed in the axial direction in a case where the magnet accommodation hole portion in which a magnet is accommodated has a rectangular shape when viewed in the axial direction, like the first magnet holes 51a and 51b of the present embodiment. That is, for example, in the present embodiment, “direction in which the first magnet hole 51a extends when viewed in the axial direction” is a direction in which a long side of the magnet accommodation hole portion 51c extends when viewed in the axial direction.

The rotor core 30 has a first hole portion 81 located between a pair of the first magnet holes 51a and 51b in the circumferential direction. One of the first hole portions 81 is provided in each of the magnet holding portions 31. That is, each of a plurality of the magnet holding portions 31 has the first hole portion 81. The oil O as a refrigerant flows into the first hole portion 81 through the flow path 90 to be described later. The first hole portion 81 extends in the axial direction. In the present embodiment, the first hole portion 81 penetrates the rotor core 30 in the axial direction. As illustrated in FIG. 3, the first hole portion 81 is provided across the core piece portion 30a and the core piece portion 30b via the groove portion 35a and the hole portion 35b provided in the plate 35. Note that the first hole portion 81 may be a hole having a bottom portion in the axial direction.

As illustrated in FIG. 5, the first hole portion 81 is provided at a position overlapping the first virtual line Ld when viewed in the axial direction. In each of the magnet holding portions 31, the first virtual line Ld is provided at a position at which to divide the first hole portion 81 in the circumferential direction. In description below of the first hole portion 81, one side in the circumferential direction is a side (+θ side) to which an arrow θ appropriately illustrated in each drawing is directed, and the other side in the circumferential direction is a side (−θ side) opposite to the side to which the arrow θ is directed. The arrow θ indicates the circumferential direction.

The first hole portion 81 has an asymmetric shape across the first virtual line Ld. For this reason, size of a portion located further on the one side in the circumferential direction than the first virtual line Ld in the first hole portion 81 can be made different from size of a portion located further on the other side in the circumferential direction than the first virtual line Ld in the first hole portion 81. By the above, a portion located on one side of the first virtual line Ld in the first hole portion 81 can be made large to increase an amount of the oil O as a refrigerant flowing into the portion, and a portion located on the other side of the first virtual line Ld in the first hole portion 81 can be made small to suppress lowering in rigidity of the rotor core 30. Here, in a pair of the first magnets 41a and 41b arranged in a pair of the first magnet holes 51a and 51b arranged with the first virtual line Ld interposed between them, degree of cooling required may be different from each other due to a rotation direction of the rotor core 30 or the like. Therefore, by enlarging a portion of the first hole portion 81 on the side close to a first magnet where cooling degree needs to be relatively large and reducing size of a portion of the first hole portion 81 on the side close to the first magnet where cooling degree may be relatively small, it is possible to prevent size of the first hole portion 81 from becoming larger than necessary while cooling each of a pair of the first magnets 41a and 41b at suitable cooling degree. Therefore, it is possible to easily cool the first magnets 41a and 41b held by the rotor core 30 while securing rigidity of the rotor core 30.

In the present embodiment, since the rotor core 30 has the second magnet holes 52a and 52b located on the outer side in the radial direction of the first hole portion 81, the second magnets 42a and 42b held in the second magnet holes 52a and 52b can also be easily cooled by the oil O flowing in the first hole portion 81. Further, since a pair of the second magnet holes 52a and 52b are arranged adjacent to each other in the circumferential direction with the first virtual line Ld interposed between them, a pair of the second magnets 42a and 42b held in a pair of the second magnet holes 52a and 52b can be easily cooled at suitable cooling degree, similarly to a pair of the first magnets 41a and 41b described above.

Note that “the first hole portion 81 has an asymmetric shape across the first virtual line Ld when viewed in the axial direction” only needs to be that a shape of a portion located further on the one side in the circumferential direction than the first virtual line Ld in the first hole portion 81 and a shape of a portion located further on the other side in the circumferential direction than the first virtual line Ld in the first hole portion 81 are not shapes that are line-symmetric with each other with the first virtual line Ld as a symmetry axis when viewed in the axial direction.

In a cross section orthogonal to the axial direction, a cross-sectional area of a first portion 81a located further on the one side in the circumferential direction (+θ side) than the first virtual line Ld in the first hole portion 81 is smaller than a cross-sectional area of a second portion 81b located further on the other side in the circumferential direction (−θ side) than the first virtual line Ld in the first hole portion 81. For this reason, an amount of the oil O flowing into the second portion 81b can be increased, and a magnet located further on the other side in the circumferential direction than the first virtual line Ld among magnets held by the magnet holding portion 31 can be easily cooled. Further, it is possible to suppress lowering in rigidity in a portion located on the one side in the circumferential direction of the first virtual line Ld in the magnet holding portion 31.

A dimension in the circumferential direction of the first portion 81a located further on the one side in the circumferential direction (+θ side) than the first virtual line Ld in the first hole portion 81 is smaller than a dimension in the circumferential direction of the second portion 81b located further on the other side in the circumferential direction (−θ side) than the first virtual line Ld in the first hole portion 81. For this reason, in a cross section orthogonal to the axial direction, a cross-sectional area of the first portion 81a and a cross-sectional area of the second portion 81b can be suitably made different from each other. Further, since a dimension in the circumferential direction of the second portion 81b can be relatively made large, the second portion 81b can be easily brought close to a magnet located further on the other side in the circumferential direction than the first virtual line Ld. By the above, a magnet located further on the other side in the circumferential direction than the first virtual line Ld can be more suitably cooled by the oil O flowing in the second portion 81b.

Here, in the present embodiment, a direction in which the rotor 10 rotates is a direction in which the arrow θ indicating the circumferential direction is directed. That is, the one side in the circumferential direction (+θ side) is the front side in a rotation direction of the rotor 10, and the other side in the circumferential direction (−θ side) is the rear side in a rotation direction of the rotor 10. Therefore, in the present embodiment, the first portion 81a of the first hole portion 81 is located further on the front side (+θ side) than the first virtual line Ld in the rotation direction of the rotor 10. The second portion 81b of the first hole portion 81 is located further on the rear side (−θ side) than the first virtual line Ld in the rotation direction of the rotor 10. Note that, in description below, the front side in the rotation direction of the rotor 10 may be simply referred to as “front side in the rotation direction”, and the rear side in the rotation direction of the rotor 10 may be simply referred to as “rear side in the rotation direction”.

In a case where the rotating electric machine 60 is driven to rotate the rotor 10, a demagnetizing field generated in a magnet located further on the rear side in a rotation direction (−θ side) than the first virtual line Ld among magnets held by the magnet holding portion 31 is larger than a demagnetizing field generated in a magnet located further on the front side in the rotation direction (+θ side) than the first virtual line Ld. For this reason, a magnet located further on the rear side in the rotation direction than the first virtual line Ld is more likely to be demagnetized than a magnet located further on the front side in the rotation direction than the first virtual line Ld due to influence of a demagnetizing field. In the present embodiment, since the second portion 81b located on the rear side in the rotation direction in the first hole portion 81 is relatively large, a magnet that is easily demagnetized can be more suitably cooled by the oil O flowing in the second portion 81b. By the above, it is possible to suitably suppress demagnetization of a magnet located further on the rear side in the rotation direction than the first virtual line Ld. On the other hand, since a magnet located further on the front side in the rotation direction than the first virtual line Ld is less likely to be demagnetized than a magnet located further on the rear side in the rotation direction than the first virtual line Ld, the first portion 81a can be made smaller than the second portion 81b. By the above, it is possible to suitably suppress lowering in rigidity of a portion located on the front side in the rotation direction of the magnet holding portion 31.

Note that, in the present embodiment, among magnets held by the magnet holding portion 31, magnets located further on the front side in the rotation direction (+θ side) than the first virtual line Ld are the first magnet 41a and the second magnet 42a. Among magnets held by the magnet holding portion 31, magnets located further on the rear side in the rotation direction (−θ side) than the first virtual line Ld are the first magnet 41b and the second magnet 42b.

The first hole portion 81 extends in a substantially circumferential direction as a whole when viewed in the axial direction. That is, a dimension in the circumferential direction of the first hole portion 81 is larger than a dimension in the radial direction of the first hole portion 81. For this reason, the second portion 81b can be suitably brought close to a magnet located further on the rear side in the rotation direction (−θ side) than the first virtual line Ld, and the magnet can be more suitably cooled by the oil O flowing in the second portion 81b. Further, since a dimension in the radial direction of the first hole portion 81 can be made relatively small, it is possible to further suppress lowering in rigidity of the rotor core 30.

The first hole portion 81 has a substantially V shape in which portions on both sides of the first virtual line Ld are bent outward in the radial direction when viewed in the axial direction. Width of the first hole portion 81 extending in a substantially V shape when viewed in the axial direction is substantially the same over the entire first hole portion 81. The first portion 81a located further on the one side in the circumferential direction (+θ side) than the first virtual line Ld in the first hole portion 81 obliquely extends from the first virtual line Ld in a direction inclined outward in the radial direction with respect to a direction to the one side in the circumferential direction (+θ side) when viewed in the axial direction. The first portion 81a is located on the outer side in the radial direction of the first magnet hole 51a and on the inner side in the radial direction of the second magnet hole 52a.

An inner wall of the first portion 81a includes a first inner wall portion 81c, a second inner wall portion 81d, and a third inner wall portion 81e. The first inner wall portion 81c and the third inner wall portion 81e linearly extend in a direction in which the first portion 81a extends when viewed in the axial direction. The first inner wall portion 81c is a portion located on the outer side in the radial direction of the inner wall of the first portion 81a. When viewed in the axial direction, a direction in which the first inner wall portion 81c extends is the same as a direction in which the second magnet hole 52a extends. That is, when viewed in the axial direction, a portion located on the outer side in the radial direction in an inner wall of the first hole portion 81 has the first inner wall portion 81c as a portion extending along the second magnet hole 52a on the inner side in the radial direction of the second magnet hole 52a. The first inner wall portion 81c extends in a direction parallel to a long side of the magnet accommodation hole portion 52c having a rectangular shape when viewed in the axial direction. The first inner wall portion 81c is located on the outer side in the radial direction toward the one side in the circumferential direction (+θ side).

The third inner wall portion 81e is a portion located on the inner side in the radial direction in an inner wall of the first portion 81a. The third inner wall portion 81e is arranged to face the first inner wall portion 81c across the inside of the first portion 81a. When viewed in the axial direction, a direction in which the third inner wall portion 81e extends is parallel to a direction in which the first inner wall portion 81c extends. That is, the third inner wall portion 81e extends in a direction parallel to a long side of the magnet accommodation hole portion 52c having a rectangular shape when viewed in the axial direction.

When viewed in the axial direction, a direction in which the third inner wall portion 81e extends is a direction different from a direction in which the first magnet hole 51a extends. That is, when viewed in the axial direction, a portion located on the inner side in the radial direction in an inner wall of the first hole portion 81 has the third inner wall portion 81e as a portion extending in a direction different from a direction in which the first magnet hole 51a extends on the outer side in the radial direction of the first magnet hole 51a. When viewed in the axial direction, a direction in which the third inner wall portion 81e extends has a larger inclination with respect to the radial direction than a direction in which the first magnet hole 51a extends.

The second inner wall portion 81d connects the first inner wall portion 81c and the third inner wall portion 81e. More specifically, the second inner wall portion 81d connects an end portion on the one side in the circumferential direction (+θ side) of the first inner wall portion 81c and an end portion on the one side in the circumferential direction of the third inner wall portion 81e. The second inner wall portion 81d has an arc shape recessed in a direction obliquely inclined outward in the radial direction with respect to the one side in the circumferential direction when viewed in the axial direction.

The second portion 81b located further on the other side in the circumferential direction (−θ side) than the first virtual line Ld in the first hole portion 81 extends obliquely in a direction inclined outward in the radial direction with respect to a direction to the other side in the circumferential direction (−θ side) from the first virtual line Ld when viewed in the axial direction. When viewed in the axial direction, a dimension of the second portion 81b in a direction in which the second portion 81b extends is larger than a dimension of the first portion 81a in a direction in which the first portion 81a extends. The second portion 81b is located on the outer side in the radial direction of the first magnet hole 51b and on the inner side in the radial direction of the second magnet hole 52b.

An inner wall of the second portion 81b includes a first inner wall portion 81f, a second inner wall portion 81g, and a third inner wall portion 81h. The first inner wall portion 81f and the third inner wall portion 81h linearly extend in a direction in which the second portion 81b extends when viewed in the axial direction. The first inner wall portion 81f is a portion located on the outer side in the radial direction in an inner wall of the second portion 81b. When viewed in the axial direction, a direction in which the first inner wall portion 81f extends is the same as a direction in which the second magnet hole 52b extends. That is, when viewed in the axial direction, a portion located on the outer side in the radial direction in an inner wall of the first hole portion 81 has the first inner wall portion 81f as a portion extending along the second magnet hole 52b on the inner side in the radial direction of the second magnet hole 52b. The first inner wall portion 81f extends in a direction parallel to a long side of the magnet accommodation hole portion 52f having a rectangular shape when viewed in the axial direction. The first inner wall portion 81f is located on the outer side in the radial direction toward the other side in the circumferential direction (−θ side).

The first inner wall portion 81c of the first portion 81a and the first inner wall portion 81f of the second portion 81b are connected to each other on the first virtual line Ld. A smaller angle of angles formed by the first inner wall portion 81c and the first inner wall portion 81f is an obtuse angle. When viewed in the axial direction, length of the first inner wall portion 81f is larger than length of the first inner wall portion 81c.

The third inner wall portion 81h is a portion located on the inner side in the radial direction of an inner wall of the second portion 81b. The third inner wall portion 81h is arranged to face the first inner wall portion 81f across the inside of the second portion 81b. When viewed in the axial direction, a direction in which the third inner wall portion 81h extends is parallel to a direction in which the first inner wall portion 81f extends. That is, the third inner wall portion 81h extends in a direction parallel to a long side of the magnet accommodation hole portion 52f having a rectangular shape when viewed in the axial direction.

When viewed in the axial direction, a direction in which the third inner wall portion 81h extends is a direction different from a direction in which the first magnet hole 51b extends. That is, when viewed in the axial direction, a portion located on the inner side in the radial direction in an inner wall of the first hole portion 81 has the third inner wall portion 81h as a portion extending in a direction different from a direction in which the first magnet hole 51b extends on the outer side in the radial direction of the first magnet hole 51b. When viewed in the axial direction, a direction in which the third inner wall portion 81h extends has a larger inclination with respect to the radial direction than a direction in which the first magnet hole 51b extends.

The third inner wall portion 81e of the first portion 81a and the third inner wall portion 81h of the second portion 81b are connected to each other on the first virtual line Ld. A smaller angle of angles formed by the third inner wall portion 81e and the third inner wall portion 81h is an obtuse angle. When viewed in the axial direction, length of the third inner wall portion 81h is larger than length of the third inner wall portion 81e.

The second inner wall portion 81g connects the first inner wall portion 81f and the third inner wall portion 81h. More specifically, the second inner wall portion 81g connects an end portion on the other side in the circumferential direction (−θ side) of the first inner wall portion 81f and an end portion on the other side in the circumferential direction of the third inner wall portion 81h. The second inner wall portion 81g has an arc shape recessed in a direction obliquely inclined outward in the radial direction with respect to a direction to the other side in the circumferential direction when viewed in the axial direction.

In the present embodiment, when viewed in the axial direction, a shortest distance between the first hole portion 81 and the second magnet holes 52a and 52b is smaller than a shortest distance between the first hole portion 81 and the first magnet holes 51a and 51b. For this reason, the second magnets 42a and 42b held in the second magnet holes 52a and 52b can be more suitably cooled by the oil O flowing in the first hole portion 81.

Here, a larger amount of magnetic flux flowing between the rotor 10 and the stator 61 passes through a portion located further on the outer side in the radial direction in the rotor core 30, and a magnet held further on the outer side in the radial direction in the rotor core 30 is more easily demagnetized by a demagnetizing field. Further, on a magnet that is held further on the outer side in the radial direction in the rotor core 30, loss due to magnetic flux is more likely to occur, and heat is more likely to be generated. For this reason, the second magnets 42a and 42b held in the second magnet holes 52a and 52b located on the outer side in the radial direction of the first hole portion 81 are more easily demagnetized than the first magnets 41a and 41b held in the first magnet holes 51a and 51b. In the present embodiment, by arranging the first hole portion 81 close to the second magnet holes 52a and 52b, the second magnets 42a and 42b that are relatively easily demagnetized can be suitably cooled by the oil O flowing in the first hole portion 81. Therefore, demagnetization of the second magnets 42a and 42b can be suitably suppressed.

Further, in the present embodiment, as described above, when viewed in the axial direction, a portion located on the outer side in the radial direction of an inner wall of the first hole portion 81 has a portion extending along the second magnet holes 52a and 52b on the inner side in the radial direction of the second magnet holes 52a and 52b. For this reason, it is easy to make a distance between the first hole portion 81 and the second magnet holes 52a and 52b substantially uniform while bringing the first hole portion 81 and the second magnet holes 52a and 52b close to each other, and it is easy to suitably secure a magnetic path through which magnetic flux passes between the first hole portion 81 and the second magnet holes 52a and 52b. By the above, magnetic flux can easily flow between the first hole portion 81 and the second magnet holes 52a and 52b in the rotor core 30.

Further, in the present embodiment, as described above, when viewed in the axial direction, a portion located on the inner side in the radial direction of an inner wall of the first hole portion 81 has a portion extending in a direction different from a direction in which the first magnet holes 51a and 51b extend on the outer side in the radial direction of the first magnet holes 51a and 51b. For this reason, as compared with a case where a portion located on the inner side in the radial direction of an inner wall of the first hole portion 81 is along the first magnet holes 51a and 51b, it is easy to increase a distance between the first hole portion 81 and the first magnet holes 51a and 51b while preventing the first hole portion 81 from becoming larger than necessary. By the above, even if a distance between the first hole portion 81 and the second magnet holes 52a and 52b is made relatively small, a distance between the first hole portion 81 and the first magnet holes 51a and 51b can be secured relatively large. Therefore, it is easy to suitably secure a magnetic path through which magnetic flux flows between the first magnet holes 51a and 51b and the second magnet holes 52a and 52b.

In the present embodiment, a shortest distance between the first hole portion 81 and the first magnet holes 51a and 51b is a shortest distance L1b between the second portion 81b and the first magnet hole 51b. The shortest distance L1b is a distance between a portion closest to the first magnet hole 51b in the second inner wall portion 81g and an edge portion on the outer side in the radial direction of the magnet accommodation hole portion 51f of the first magnet hole 51b. The shortest distance L1b is shorter than a shortest distance L1a between the first portion 81a and the first magnet hole 51a. The shortest distance L1a is a distance between a portion closest to the first magnet hole 51a in the second inner wall portion 81d and an edge portion on the outer side in the radial direction of the magnet accommodation hole portion 51c of the first magnet hole 51a.

In the present embodiment, the shortest distance between the first hole portion 81 and the second magnet holes 52a and 52b is a shortest distance L2a between the first portion 81a and the second magnet hole 52a and a shortest distance L2b between the second portion 81b and the second magnet hole 52b. The shortest distance L2a is a distance between the first inner wall portion 81c and an edge portion on the inner side in the radial direction of the magnet accommodation hole portion 52c of the second magnet hole 52a. The shortest distance L2b is a distance between the first inner wall portion 81f and an edge portion on the inner side in the radial direction of the magnet accommodation hole portion 52f of the second magnet hole 52b. In the present embodiment, the shortest distance L2a and the shortest distance L2b are the same and smaller than the shortest distances L1a and L1b.

In the present embodiment, when viewed in the axial direction, a protruding portion 81j is provided on an inner wall of the first hole portion 81. The protruding portion 81j is provided in a portion located on the outer side in the radial direction of an inner wall of the first hole portion 81, and protrudes to the inner side in the radial direction. For this reason, it is possible to prevent the first hole portion 81 from being too close to the second magnet holes 52a and 52b, and it is possible to prevent lowering in rigidity of a portion located between the first hole portion 81 and the second magnet holes 52a and 52b of the rotor core 30.

In the present embodiment, the protruding portion 81j is provided at a position overlapping the first virtual line Ld when viewed in the axial direction. For this reason, the protruding portion 81j can be arranged on the inner side in the radial direction of the second bridge portion 36b, and a distance L4 in the radial direction between the second bridge portion 36b and the first hole portion 81 can be made large. By the above, rigidity of a portion located between the first hole portion 81 and the second magnet holes 52a and 52b of the rotor core 30 can be more suitably improved.

In the present embodiment, the protruding portion 81j is constituted by the first inner wall portion 81c and the first inner wall portion 81f. A top portion 81m of the protruding portion 81j is arranged on the first virtual line Ld when viewed in the axial direction. The top portion 81m is a portion located furthest on the inner side in the radial direction of the protruding portion 81j and is a connection portion between the first inner wall portion 81c and the first inner wall portion 81f.

In the present embodiment, a recessed portion 81i is provided in an inner wall of the first hole portion 81 when viewed in the axial direction. The recessed portion 81i is provided in a portion located on the inner side in the radial direction of an inner wall of the first hole portion 81 and is recessed to the inner side in the radial direction. For this reason, it is possible to more easily arrange the first hole portion 81 further on the inner side in the radial direction, and it is possible to further prevent the first hole portion 81 from being too close to the second magnet holes 52a and 52b. By the above, lowering in rigidity of a portion located between the first hole portion 81 and the second magnet holes 52a and 52b of the rotor core 30 can be further suppressed.

In the present embodiment, the recessed portion 81i is provided at a position overlapping the first virtual line Ld when viewed in the axial direction. For this reason, even if the protruding portion 81j is provided at a position overlapping the first virtual line Ld when viewed in the axial direction, it is possible to suppress reduction in size of a dimension in the radial dimension of a portion where the protruding portion 81j is provided in the first hole portion 81. This makes it possible to suppress reduction in an amount of the oil O flowing into the first hole portion 81.

In the present embodiment, the recessed portion 81i is constituted by the third inner wall portion 81e and the third inner wall portion 81h. A bottom portion 81k of the recessed portion 81i is arranged on the first virtual line Ld when viewed in the axial direction. That is, in the present embodiment, the bottom portion 81k of the recessed portion 81i and the top portion 81m of the protruding portion 81j are provided at positions overlapping the first virtual line Ld when viewed in the axial direction. For this reason, it is possible to further suppress reduction in size of a dimension in the radial direction of a portion where the protruding portion 81j is provided of the first hole portion 81. This makes it possible to further suppress reduction in an amount of the oil O flowing into the first hole portion 81. Further, since the bottom portion 81k of the recessed portion 81i and the top portion 81m of the protruding portion 81j are arranged in the same straight line extending in the radial direction, it is possible to suppress complication of a shape of the first hole portion 81 and to easily form the first hole portion 81. The bottom portion 81k is a portion located furthest on the inner side in the radial direction in the recessed portion 81i and is a connection portion between the third inner wall portion 81e and the third inner wall portion 81h.

As illustrated in FIG. 4, in some of the magnet holding portions 31, a position in the circumferential direction in the bottom portion 81k of the recessed portion 81i is included in a position in the circumferential direction of the projection portion 32. That is, in the present embodiment, the projection portion 32 has a portion provided at the same position in the circumferential direction as the bottom portion 81k of the recessed portion 81i. For this reason, even if the recessed portion 8li is provided in the first hole portion 81 in the magnet holding portion 31 located on the outer side in the radial direction of the projection portion 32, it is possible to suppress reduction in a dimension in the radial direction of a portion located between the first hole portion 81 and the through hole 30h in the rotor core 30. By the above, it is possible to suppress lowering in rigidity of a portion located further on the inner side in the radial direction than the first hole portion 81 in the rotor core 30.

As illustrated in FIG. 5, in the present embodiment, the distance L4 in the radial direction between the second bridge portion 36b and the first hole portion 81 is smaller than a distance L3 in the radial direction between the first bridge portion 36a and the first hole portion 81. For this reason, the first hole portion 81 can be more suitably brought close to a pair of the second magnet holes 52a and 52b, and a pair of the second magnets 42a and 42b held in a pair of the second magnet holes 52a and 52b can be more suitably cooled by the oil O flowing through the first hole portion 81.

The distance L3 in the radial direction between the first bridge portion 36a and the first hole portion 81 is a distance in the radial direction between an end portion on the outer side in the radial direction of the first bridge portion 36a and the bottom portion 81k of the recessed portion 81i. The distance L4 in the radial direction between the second bridge portion 36b and the first hole portion 81 is a distance in the radial direction between an end portion on the inner side in the radial direction of the wide portion 36d in the second bridge portion 36b and the top portion 81m of the protruding portion 81j. The distance L3 is, for example, twice or more the distance L4.

As illustrated in FIG. 4, the rotor core 30 has a second hole portion 82. The second hole portion 82 is provided at a position overlapping a second virtual line Lq that passes through the center in the circumferential direction between the magnet holding portions 31 adjacent to each other in the circumferential direction and extends in the radial direction when viewed in the axial direction. By providing the second hole portion 82, weight of the rotor core 30 can be reduced. The second virtual line Lq passes through on a q axis of the rotor 10 when viewed in the axial direction. A direction in which the second virtual line Lq extends is a q-axis direction of the rotor 10. The second virtual line Lq is provided for each space between the magnet holding portions 31. A direction in which the first virtual line Ld extends and a direction in which the second virtual line Lq extends are directions intersecting each other. The first virtual line Ld and the second virtual line Lq are alternately provided along the circumferential direction.

In the present embodiment, the second hole portion 82 is a hole penetrating the rotor core 30 in the axial direction. Note that the second hole portion 82 may be a hole having a bottom portion in the axial direction. A plurality of the second hole portions 82 are provided at intervals in the circumferential direction. In the present embodiment, eight of the second hole portions 82 are provided. Each of the second hole portions 82 is arranged on the inner side in the radial direction between the magnet holding portions 31 adjacent to each other in the circumferential direction. Each of the second hole portions 82 is located on the inner side in the radial direction of the first magnet hole 51a in one of the magnet holding portions 31 adjacent to each other in the circumferential direction and the first magnet hole 51b in another one of the magnet holding portions 31.

In the present embodiment, the second hole portion 82 has a substantially triangular shape with rounded corners protruding to the outer side in the radial direction when viewed in the axial direction. When viewed in the axial direction, the second virtual line Lq passes through the center in the circumferential direction of the second hole portion 82. In the present embodiment, the second hole portion 82 has a line-symmetric shape with the second virtual line Lq passing through the second hole portion 82 as a symmetry axis when viewed in the axial direction.

As illustrated in FIG. 1, the drive device 100 in the present embodiment is provided with the flow path 90 through which the oil O as a refrigerant flows. In the present embodiment, the flow path 90 is a flow path for supplying the oil O stored in the gear housing 63b to the rotor 10 and the stator 61. The flow path 90 is provided with a pump 96 and a cooler 97. The flow path 90 includes a first flow path portion 91, a second flow path portion 92, a third flow path portion 93, a fourth flow path portion 94, and a fifth flow path portion 95.

The first flow path portion 91, the second flow path portion 92, and the third flow path portion 93 are provided in a wall portion of the gear housing 63b, for example. The first flow path portion 91 connects a portion storing the oil O inside the gear housing 63b and the pump 96. The second flow path portion 92 connects the pump 96 and the cooler 97. The third flow path portion 93 connects the cooler 97 and the fourth flow path portion 94. In the present embodiment, the third flow path portion 93 is connected to an end portion on the one side in the axial direction (+Y side) of the fourth flow path portion 94, that is, an upstream side portion of the fourth flow path portion 94.

In the present embodiment, the fourth flow path portion 94 has a tubular shape extending in the axial direction. In other words, in the present embodiment, the fourth flow path portion 94 is a pipe extending in the axial direction. Both end portions in the axial direction of the fourth flow path portion 94 are supported by the motor housing 63a. An end portion on the one side in the axial direction (+Y side) of the fourth flow path portion 94 is supported by, for example, the partition wall portion 63d. An end portion on the other side in the axial direction (−Y side) of the fourth flow path portion 94 is supported by, for example, the lid portion 63e. The fourth flow path portion 94 is located on the outer side in the radial direction of the stator 61. In the present embodiment, the fourth flow path portion 94 is located above the stator 61.

The fourth flow path portion 94 has a supply port 94a for supplying the oil O to the stator 61. In the present embodiment, the supply port 94a is an injection port that injects a part of the oil flowing into the fourth flow path portion 94 to the outside of the fourth flow path portion 94. The supply port 94a is constituted by a hole penetrating a wall portion of the fourth flow path portion 94 from an inner peripheral surface to an outer peripheral surface. A plurality of the supply ports 94a are provided in the fourth flow path portion 94.

The fifth flow path portion 95 connects the fourth flow path portion 94 and the inside of the shaft 20 that is hollow. More specifically, the fifth flow path portion 95 connects an end portion on the other side in the axial direction (−Y side) of the fourth flow path portion 94 and an end portion on the other side in the axial direction of the shaft 20. In the present embodiment, the fifth flow path portion 95 is provided in the lid portion 63e.

As illustrated in FIG. 1, when the pump 96 is driven, the oil O stored in the gear housing 63b is sucked up through the first flow path portion 91, and flows into the cooler 97 through the second flow path portion 92. The oil O flowing into the cooler 97 is cooled in the cooler 97, and then flows to the fourth flow path portion 94 through the third flow path portion 93. A part of the oil O flowing into the fourth flow path portion 94 is injected from the supply port 94a and supplied to the stator 61. Another part of the oil O flowing into the fourth flow path portion 94 flows into the shaft 20 through the fifth flow path portion 95.

The oil O flowing into the shaft 20 from the fifth flow path portion 95 flows in a direction to the one side in the axial direction (+Y side direction) in the axial direction in the shaft 20. As illustrated in FIG. 3, a part of the oil O flowing inside the shaft 20 flows into the groove portion 35a of the plate 35 from the hole portion 22 of the shaft 20. The oil O flowing into the groove portion 35a flows to the outer side in the radial direction and flows into the first hole portion 81. More specifically, a part of the oil O flowing into the groove portion 35a flows into a portion provided in the core piece portion 30b in the first hole portion 81 from an end portion on the outer side in the radial direction of the groove portion 35a. Another part of the oil O flowing into the groove portion 35a flows into a portion provided in the core piece portion 30a in the first hole portion 81 from an end portion on the outer side in the radial direction of the groove portion 35a via the hole portion 35b. The oil O flowing into the first hole portion 81 flows in the axial direction and scatters to the outer side in the radial direction toward the stator 61 from an end portion in the axial direction of the rotor core 30 as illustrated in FIG. 1.

Another part of the oil O flowing inside the shaft 20 is discharged from an opening on the one side in the axial direction of the shaft 20 to the inside of the gear housing 63b and stored again in the gear housing 63b. The oil O supplied from the supply port 94a and the first hole portion 81 to the stator 61 falls downward and accumulates in a lower region in the motor housing 63a. The oil O accumulated in a lower region in the motor housing 63a returns into the gear housing 63b via the partition wall opening 63f provided in the partition wall portion 63d.

Hereinafter, an embodiment different from the above-described first embodiment will be described. In the description of each embodiment below, a similar configuration to that of the first embodiment described above may be denoted by the same reference sign as appropriate so as to be omitted from description. Further, as a configuration where description is omitted in each embodiment below, a similar configuration to that of the first embodiment described above can be employed in a range where no conflict arises.

### Second Embodiment

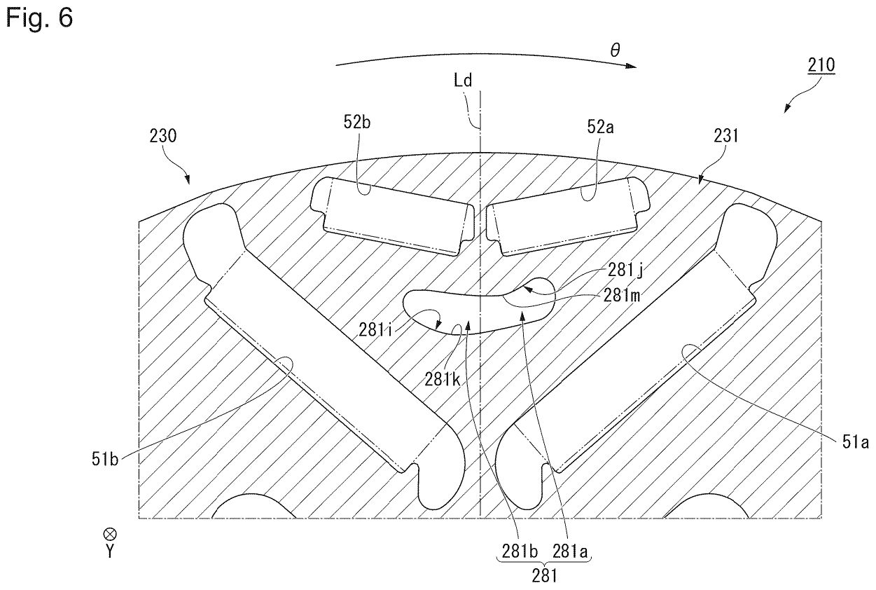

As illustrated in FIG. 6, in a rotor core 230 of a rotor 210 of the present embodiment, a first hole portion 281 of a magnet holding portion 231 is different from that of the first embodiment in arrangement of a recessed portion 281i and a protruding portion 281j. The recessed portion 281i is provided in a portion located on the inner side in the radial direction of an inner wall of a second portion 281b of the first hole portion 281. A bottom portion 281k of the recessed portion 281i is located further on the other side in the circumferential direction (−θ side) than the first virtual line Ld. The protruding portion 281j is provided in a portion located on the outer side in the radial direction of an inner wall of a first portion 281a of the first hole portion 281. A top portion 281m of the protruding portion 281j is located further on the one side in the circumferential direction (+θ side) than the first virtual line Ld.

The bottom portion 281k of the recessed portion 281i and the top portion 281m of the protruding portion 281j are arranged to be shifted from each other in the circumferential direction. For this reason, it is easy to increase a dimension in the radial direction of the first hole portion 281 in a portion where the recessed portion 281i is provided, and it is easy to reduce a dimension in the radial direction of the first hole portion 281 in a portion where the protruding portion 281j is provided. By the above, it is easy to suitably make size of the first portion 281a and size of the second portion 281b different from each other. In the present embodiment, the second portion 281b provided with the recessed portion 281i on an inner wall can be made large, and the first portion 281a provided with the protruding portion 281j on an inner wall can be made small. In a cross section orthogonal to the axial direction, a cross-sectional area of the first portion 281a located on the one side in the circumferential direction (+θ side) of the first virtual line Ld in the first hole portion 281 is smaller than a cross-sectional area of the second portion 281b located on the other side in the circumferential direction (−θ side) of the first virtual line Ld in the first hole portion 281.

### Third Embodiment

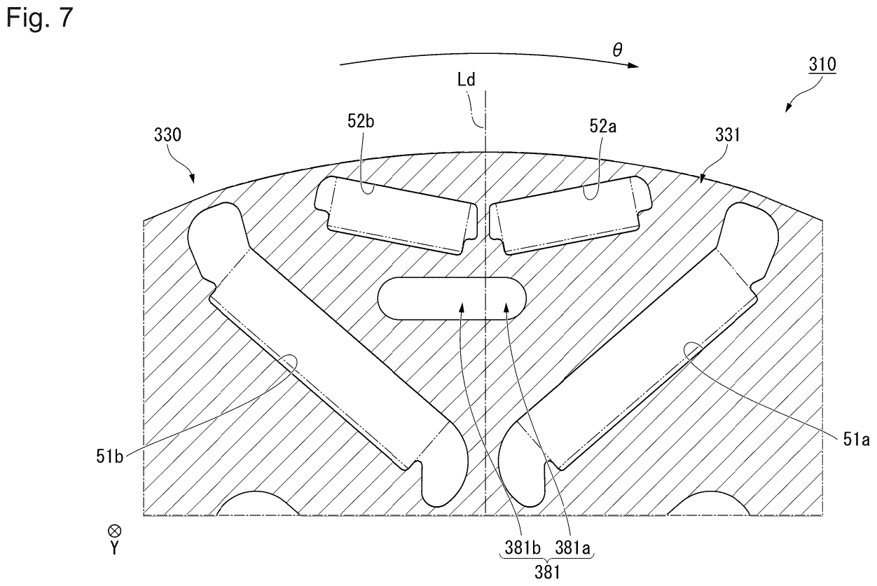

As illustrated in FIG. 7, in a rotor core 330 of a rotor 310 of the present embodiment, a first hole portion 381 of a magnet holding portion 331 has a shape extending linearly when viewed in the axial direction. The first hole portion 381 is an elongated hole extending in a direction orthogonal to the first virtual line Ld when viewed in the axial direction. When viewed in the axial direction, the center in a direction in which the first hole portion 381 extends is located further on the other side in the circumferential direction (−θ side) than the first virtual line Ld. In a cross section orthogonal to the axial direction, a cross-sectional area of a first portion 381a located further on the one side in the circumferential direction (+θ side) than the first virtual line Ld in the first hole portion 381 is smaller than a cross-sectional area of a second portion 381b located further on the other side in the circumferential direction (−θ side) than the first virtual line Ld in the first hole portion 381.

### Fourth Embodiment

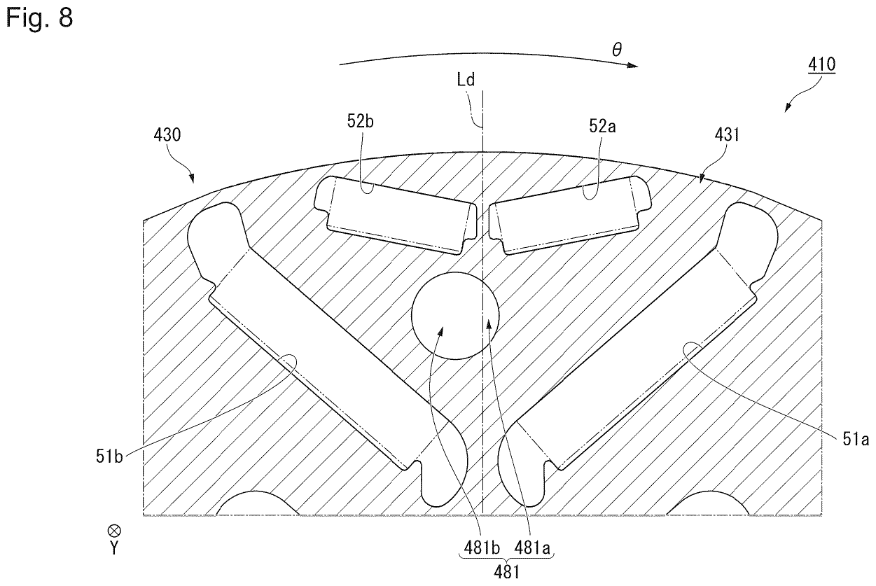

As illustrated in FIG. 8, in a rotor core 430 of a rotor 410 of the present embodiment, a first hole portion 481 of a magnet holding portion 431 has a circular shape when viewed in the axial direction. More specifically, the first hole portion 481 has a perfect circular shape when viewed in the axial direction. The center of the first hole portion 481 having a circular shape is located further on the other side in the circumferential direction (−θ side) than the first virtual line Ld. In a cross section orthogonal to the axial direction, a cross-sectional area of a first portion 481a located further on the one side in the circumferential direction (+θ side) than the first virtual line Ld in the first hole portion 481 is smaller than a cross-sectional area of a second portion 481b located further on the other side in the circumferential direction (-e side) than the first virtual line Ld in the first hole portion 481. Note that the first hole portion 481 may have an elliptical shape or a partially distorted circular shape when viewed in the axial direction.

### fifth Embodiment

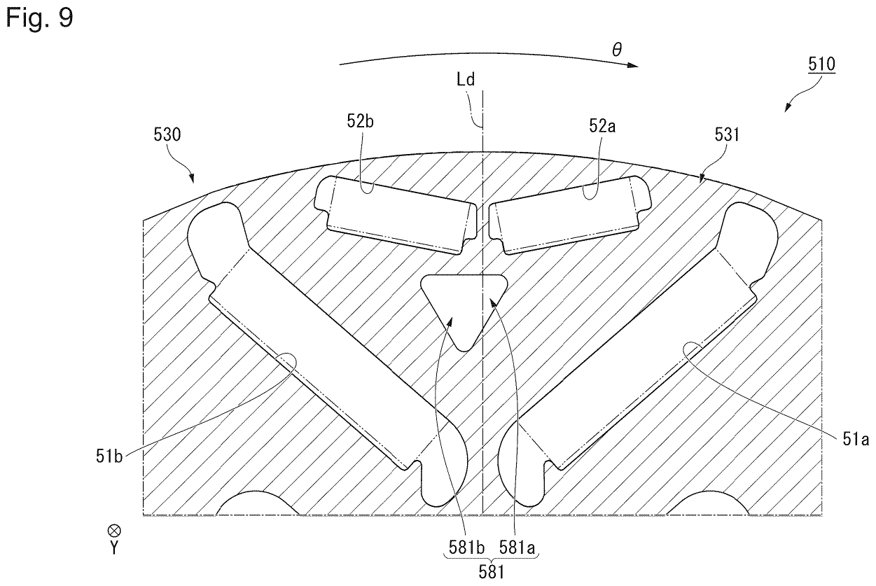

As illustrated in FIG. 9, in a rotor core 530 of a rotor 510 of the present embodiment, a first hole portion 581 of a magnet holding portion 531 has a triangular shape with rounded corners protruding to the inner side in the radial direction when viewed in the axial direction. A corner portion on the inner side in the radial direction of the first hole portion 581 having a triangular shape is located further on the other side in the circumferential direction (−θ side) than the first virtual line Ld. In a cross section orthogonal to the axial direction, a cross-sectional area of a first portion 581a located further on the one side in the circumferential direction (+θ side) than the first virtual line Ld in the first hole portion 581 is smaller than a cross-sectional area of a second portion 581b located further on the other side in the circumferential direction (−θ side) than the first virtual line Ld in the first hole portion 581.

### Sixth Embodiment

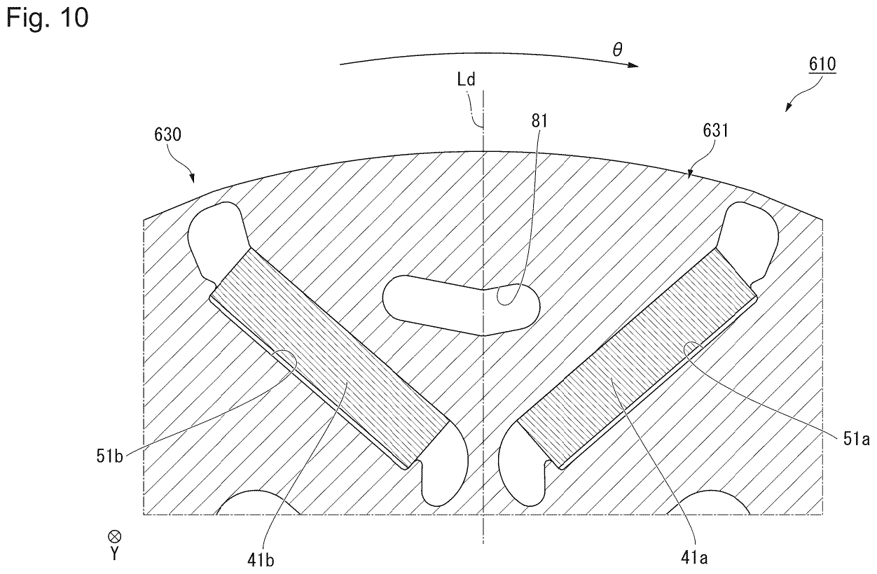

As illustrated in FIG. 10, in a rotor core 630 of a rotor 610 of the present embodiment, a magnet holding portion 631 does not have the second magnet holes 52a and 52b. By the above, the rotor 610 does not include the second magnets 42a and 42b. In the present embodiment, the magnet holding portion 631 holds only two of the first magnets 41a and 41b. Also in the rotor 610, by forming the first hole portion 81 into an asymmetric shape across the first virtual line Ld, it is possible to easily cool the first magnets 41a and 41b held by the rotor core 630 while securing rigidity of the rotor core 630.

### Seventh Embodiment

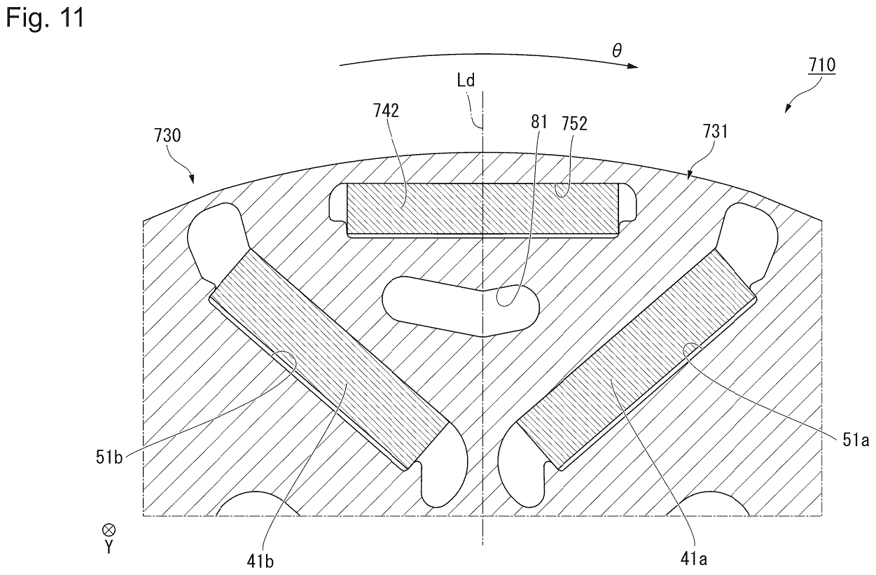

As illustrated in FIG. 11, in a rotor core 730 of a rotor 710 of the present embodiment, a magnet holding portion 731 includes a pair of the first magnet holes 51a and 51b and one second magnet hole 752. One of the second magnet hole 752 extends linearly in a direction orthogonal to the first virtual line Ld when viewed in the axial direction. The second magnet hole 752 is arranged at a position overlapping the first virtual line Ld when viewed in the axial direction. The second magnet hole 752 has a line-symmetric shape with the first virtual line Ld as a symmetry axis. A pair of the first magnet holes 51a and 51b and one of the second magnet hole 752 are arranged along a ∇ shape when viewed in the axial direction.

In the present embodiment, in the magnet holding portion 731, a pair of the first magnets 41a and 41b held in a pair of the first magnet holes 51a and 51b, respectively, and one second magnet 742 held in one of the second magnet hole 752 are arranged along a ∇ shape when viewed in the axial direction. Also in the rotor 710, by forming the first hole portion 81 into an asymmetric shape across the first virtual line Ld, it is possible to easily cool the first magnets 41a and 41b and the second magnet 742 held by the rotor core 730 while securing rigidity of the rotor core 730.

The present invention is not limited to the above-described embodiment, and other configurations and other methods can be employed within the scope of the technical idea of the present invention. The first hole portion may have any shape or may be arranged in any manner as long as the first hole portion is provided at a position overlapping the first virtual line passing through the center in the circumferential direction between a pair of the first magnet holes and extending in the radial direction when viewed in the axial direction, and has an asymmetric shape across the first virtual line. In a cross section orthogonal to the axial direction, a cross-sectional area of the first portion located further on the one side in the circumferential direction than the first virtual line in the first hole portion may be the same as a cross-sectional area of the second portion located on the other side in the circumferential direction than the first virtual line in the first hole portion, or may be larger than the cross-sectional area of the second portion. A dimension in the circumferential direction of the first portion located further on the one side in the circumferential direction than the first virtual line in the first hole portion may be the same as a dimension in the circumferential direction of the second portion located further on the other side in the circumferential direction than the first virtual line in the first hole portion, or may be larger than a dimension in the circumferential direction of the second portion. A type of a refrigerant supplied into the first hole portion is not particularly limited. A method of supplying a refrigerant into the first hole portion may be any method.

When viewed in the axial direction, a shortest distance between the first hole portion and the second magnet hole may be the same as a shortest distance between the first hole portion and the first magnet hole, or may be larger than a shortest distance between the first hole portion and the first magnet hole. A distance in the radial direction between the second bridge portion located between a pair of the second magnet holes and the first hole portion may be the same as a distance in the radial direction between the first bridge portion located between a pair of the first magnet holes and the first hole portion, or may be larger than a distance in the radial direction between the first bridge portion and the first hole portion.

When viewed in the axial direction, an inner wall of the first hole portion may be provided with only one of a recessed portion provided in a portion located on the inner side in the radial direction of the inner wall of the first hole portion and recessed to the inner side in the radial direction and a protruding portion provided in a portion located on the outer side in the radial direction of the inner wall of the first hole portion and protruding to the inner side in the radial direction, or may not be provided with both. In the inner wall of the first hole portion, a position where the recessed portion is provided and a position where the protruding portion is provided are not particularly limited. A plurality of the recessed portions and protruding portions may be provided on an inner wall of one first hole portion.

The number of the first hole portions provided in one magnet holding portion is not particularly limited as long as the number is one or more. In a case where a plurality of the first hole portions are provided in one magnet holding portion, a plurality of the first hole portions may be arranged side by side at intervals in the radial direction. In a case where a plurality of the first hole portions are provided in one magnet holding portion, a plurality of the first hole portions may all have the same shape or may all have different shapes. A plurality of the magnet holding portions may include a magnet holding portion in which the first hole portion is not provided. The rotor core only needs to have the first hole portion in at least one magnet holding portion. The magnet holding portion may have any other hole as long as the magnet holding portion has a pair of the first magnet holes and the first hole portion. The number of the magnet holding portions is not particularly limited as long as the number is one or more. When viewed in the axial direction, the second hole portion does not need to be provided at a position overlapping the second virtual line passing through the center in the circumferential direction between the magnet holding portions adjacent in the circumferential direction and extending in the radial direction.

In a case where the rotor core includes a plurality of core piece portions arranged side by side in the axial direction, each of a plurality of the core piece portions may have a plurality of magnet holding portions having a pair of the first magnet holes and the first hole portion. In a case where the rotor core includes a plurality of core piece portions, the number of the core piece portions is not particularly limited as long as the number is two or more.

The rotating electric machine to which the present invention is applied is not limited to a motor, and may be a generator. The application of the rotating electric machine is not particularly limited. The rotating electric machine may be mounted in equipment other than a vehicle. The application of the drive device to which the present invention is applied is not particularly limited. For example, the drive device may be mounted in a vehicle for an application other than the application of rotating an axle, or may be mounted in equipment other than a vehicle. A posture when the rotating electric machine and the drive device are used is not particularly limited. A central axis of the rotating electric machine may be inclined with respect to the horizontal direction orthogonal to the vertical direction or may extend in the vertical direction.

Note that the present technique can have a configuration as described below.

(1) A rotor core of a rotor rotatable around a central axis, the rotor core including a pair of first magnet holes adjacent to each other in a circumferential direction, and a first hole portion located between the pair of first magnet holes in the circumferential direction, in which the pair of first magnet holes extend in directions away from each other in the circumferential direction from an inner side in a radial direction toward an outer side in the radial direction when viewed in an axial direction, and the first hole portion is provided at a position overlapping a first virtual line passing through a center in the circumferential direction between the pair of first magnet holes and extending in the radial direction when viewed in the axial direction, and has an asymmetric shape across the first virtual line.

(2) The rotor core according to (1), in which in a cross section orthogonal to the axial direction, a cross-sectional area of a first portion located further on one side in the circumferential direction than the first virtual line in the first hole portion is smaller than a cross-sectional area of a second portion located further on another side in the circumferential direction than the first virtual line in the first hole portion.

(3) The rotor core according to (1) or (2), in which a dimension in the circumferential direction of a first portion located further on one side in the circumferential direction than the first virtual line in the first hole portion is smaller than a dimension in the circumferential direction of a second portion located further on another side in the circumferential direction than the first virtual line in the first hole portion.

(4) The rotor core according to (2) or (3), in which the first portion is located further on a front side than the first virtual line in a rotation direction of the rotor, and the second portion is located further on a rear side than the first virtual line in the rotation direction of the rotor.

(5) The rotor core according to any one of (1) to (4), in which a dimension in the circumferential direction of the first hole portion is larger than a dimension in the radial direction of the first hole portion.

(6) The rotor core according to any one of (1) to (5), further including a second magnet hole located on the outer side in the radial direction of the first hole portion.

(7) The rotor core according to (6), in which a shortest distance between the first hole portion and the second magnet hole is smaller than a shortest distance between the first hole portion and the first magnet hole when viewed in the axial direction.

(8) The rotor core according to (6) or (7), in which a pair of the second magnet holes are provided adjacent to each other in the circumferential direction, the pair of second magnet holes extend in directions away from each other in the circumferential direction from an inner side in the radial direction toward an outer side in the radial direction when viewed in the axial direction, and the first virtual line passes between the pair of second magnet holes when viewed in the axial direction.

(9) The rotor core according to (8), further including a first bridge portion located between the pair of first magnet holes, and a second bridge portion located between the pair of second magnet holes, in which a distance in the radial direction between the second bridge portion and the first hole portion is smaller than a distance in the radial direction between the first bridge portion and the first hole portion.

(10) The rotor core according to any one of (6) to (9), in which when viewed in the axial direction, an inner wall of the first hole portion is provided with at least one of a recessed portion provided in a portion located on an inner side in the radial direction in the inner wall of the first hole portion and recessed to the inner side in the radial direction and a protruding portion provided in a portion located on an outer side in the radial direction in the inner wall of the first hole portion and protruding to the inner side in the radial direction.

(11) The rotor core according to (10), in which the protruding portion is provided on the inner wall of the first hole portion when viewed in the axial direction, and the protruding portion is provided at a position overlapping the first virtual line when viewed in the axial direction.

(12) The rotor core according to (11), in which the recessed portion is provided in the inner wall of the first hole portion when viewed in the axial direction, and a bottom portion of the recessed portion and a top portion of the protruding portion are provided at positions overlapping the first virtual line when viewed in the axial direction.

(13) The rotor core according to (10), in which both the recessed portion and the protruding portion are provided in the inner wall of the first hole portion when viewed in the axial direction, and a bottom portion of the recessed portion and a top portion of the protruding portion are arranged to be shifted from each other in the circumferential direction.

(14) The rotor core according to (12) or (13), further including a through hole penetrating the rotor core in the axial direction, in which the central axis passes through an inside of the through hole, a projection portion protruding to the inner side in the radial direction is provided on an inner edge of the through hole, and the projection portion has a portion provided at the same position in the circumferential direction as a bottom portion of the recessed portion.

(15) The rotor core according to any one of (8) to (14), in which a portion located on the outer side in the radial direction in an inner wall of the first hole portion has a portion extending along the second magnet hole on the inner side in the radial direction of the second magnet hole when viewed in the axial direction.

(16) The rotor core according to any one of (8) to (15), in which a portion located on the inner side in the radial direction in an inner wall of the first hole portion has a portion extending in a direction different from a direction in which the first magnet hole extends on the outer side in the radial direction of the first magnet hole when viewed in the axial direction.

(17) The rotor core according to any one of (1) to (16), further including a plurality of magnet holding portions each having the pair of first magnet holes and the first hole portion and arranged side by side in the circumferential direction, and a second hole portion provided at a position overlapping a second virtual line passing through the center in the circumferential direction between the magnet holding portions adjacent to each other in the circumferential direction and extending in the radial direction when viewed in the axial direction.

(18) A rotating electric machine including a rotor including the rotor core according to any one of (1) to (17), and a stator facing the rotor with a gap interposed between them in the radial direction.

(19) A drive device including the rotating electric machine according to (18), and a gear mechanism connected to the rotating electric machine.

The configurations described above in the present description may be appropriately combined in a range where no conflict arises.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotor core of a rotor rotatable around a central axis, the rotor core comprising:
a pair of first magnet holes adjacent to each other in a circumferential direction; and
a first hole portion located between the pair of first magnet holes in the circumferential direction, wherein
the pair of first magnet holes extend in directions away from each other in the circumferential direction from an inner side in a radial direction toward an outer side in the radial direction when viewed in an axial direction, and
the first hole portion is provided at a position overlapping a first virtual line passing through a center in the circumferential direction between the pair of first magnet holes and extending in the radial direction when viewed in the axial direction, and has an asymmetric shape across the first virtual line.

2. The rotor core according to claim 1, wherein in a cross section orthogonal to the axial direction, a cross-sectional area of a first portion located further on one side in the circumferential direction than the first virtual line in the first hole portion is smaller than a cross-sectional area of a second portion located further on another side in the circumferential direction than the first virtual line in the first hole portion.

3. The rotor core according to claim 1, wherein a dimension in the circumferential direction of a first portion located further on one side in the circumferential direction than the first virtual line in the first hole portion is smaller than a dimension in the circumferential direction of a second portion located further on another side in the circumferential direction than the first virtual line in the first hole portion.

4. The rotor core according to claim 2, wherein
the first portion is located further on a front side than the first virtual line in a rotation direction of the rotor, and
the second portion is located further on a rear side than the first virtual line in the rotation direction of the rotor.

5. The rotor core according to claim 1, wherein a dimension in the circumferential direction of the first hole portion is larger than a dimension in the radial direction of the first hole portion.

6. The rotor core according to claim 1, comprising a second magnet hole located on the outer side in the radial direction of the first hole portion.

7. The rotor core according to claim 6, wherein a shortest distance between the first hole portion and the second magnet hole is smaller than a shortest distance between the first hole portion and the first magnet hole when viewed in the axial direction.

8. The rotor core according to claim 6, wherein
a pair of the second magnet holes are provided adjacent to each other in the circumferential direction,
the pair of second magnet holes extend in directions away from each other in the circumferential direction from an inner side in the radial direction toward an outer side in the radial direction when viewed in the axial direction, and
the first virtual line passes between the pair of second magnet holes when viewed in the axial direction.

9. The rotor core according to claim 8, comprising:
a first bridge portion located between the pair of first magnet holes; and
a second bridge portion located between the pair of second magnet holes, wherein
a distance in the radial direction between the second bridge portion and the first hole portion is smaller than a distance in the radial direction between the first bridge portion and the first hole portion.

10. The rotor core according to claim 6, wherein when viewed in the axial direction, an inner wall of the first hole portion is provided with at least one of a recessed portion provided in a portion located on an inner side in the radial direction in the inner wall of the first hole portion and recessed to the inner side in the radial direction and a protruding portion provided in a portion located on an outer side in the radial direction in the inner wall of the first hole portion and protruding to the inner side in the radial direction.

11. The rotor core according to claim 10, wherein
the protruding portion is provided on the inner wall of the first hole portion when viewed in the axial direction, and
the protruding portion is provided at a position overlapping the first virtual line when viewed in the axial direction.

12. The rotor core according to claim 11, wherein
the recessed portion is provided in the inner wall of the first hole portion when viewed in the axial direction, and
a bottom portion of the recessed portion and a top portion of the protruding portion are provided at positions overlapping the first virtual line when viewed in the axial direction.

13. The rotor core according to claim 10, wherein
both the recessed portion and the protruding portion are provided in the inner wall of the first hole portion when viewed in the axial direction, and
a bottom portion of the recessed portion and a top portion of the protruding portion are arranged to be shifted from each other in the circumferential direction.

14. The rotor core according to claim 12, comprising a through hole penetrating the rotor core in the axial direction, wherein
the central axis passes through an inside of the through hole,
a projection portion protruding to the inner side in the radial direction is provided on an inner edge of the through hole, and
the projection portion has a portion provided at a same position in the circumferential direction as a bottom portion of the recessed portion.

15. The rotor core according to claim 8, wherein a portion located on the outer side in the radial direction in an inner wall of the first hole portion has a portion extending along the second magnet hole on the inner side in the radial direction of the second magnet hole when viewed in the axial direction.

16. The rotor core according to claim 8, wherein a portion located on the inner side in the radial direction in an inner wall of the first hole portion has a portion extending in a direction different from a direction in which the first magnet hole extends on the outer side in the radial direction of the first magnet hole when viewed in the axial direction.

17. The rotor core according to claim 1, comprising:
a plurality of magnet holding portions each having the pair of first magnet holes and the first hole portion and arranged side by side in the circumferential direction; and
a second hole portion provided at a position overlapping a second virtual line passing through a center in the circumferential direction between the magnet holding portions adjacent to each other in the circumferential direction and extending in the radial direction when viewed in the axial direction.

18. A rotating electric machine comprising:
a rotor including the rotor core according to claim 1; and
a stator facing the rotor with a gap interposed therebetween in the radial direction.

19. A drive device comprising:
the rotating electric machine according to claim 18; and
a gear mechanism connected to the rotating electric machine.
